(19) United States
(12) Patent Application Publication
(10) Pub. No.: US 2018/0100548 A1
(43) Pub. Date: Apr. 12, 2018

(54) SELF-LOCKING DEVICE OF ELECTRIC TOOL OUTPUT SHAFT

(71) Applicant: Dongguan Best Electric Tools Co., Ltd., Dongguan City (CN)

(72) Inventors: Qiang WANG, Dongguan City (CN); Yi-Tung CHIU, Dongguan City (CN)

(21) Appl. No.: 15/286,738

(22) Filed: Oct. 6, 2016

(51) Int. Cl. F16D 1/04; B23B 31/12; B23B 31/00; B25B 23/00

(52) U.S. Cl. CPC F16D 1/04; B23B 31/12; B23B 2231/46; B25B 23/0035; B23B 31/008

(57) ABSTRACT

A self-locking device of an electric tool output shaft includes a main shaft, a power output disk, a stop ring, and a plurality of self-locking pins. An upper end surface of the power output disk is provided with a plurality of drive blocks. A bottom of the main shaft is inserted into the power output disk. An inner side of the power output disk is provided with a plurality of drive surfaces. An outer wall of a lower end of the main shaft is provided with a plurality of driven surfaces and a plurality of self-locking surfaces. The main shaft has the driven surfaces to lean against the drive surfaces and the power output disk to accomplish a power output function, and further has the self-locking surfaces to lean against the self-locking pins to accomplish a self-locking function.

### FIELD OF THE INVENTION

The present invention relates to an electric tool, and more particularly to a self-locking device of an electric tool output shaft.

### BACKGROUND OF THE INVENTION

A rotary electric tool can be used as an electric drill or an electric screwdriver, with a suitable clamping chuck to clamp a drill bit or a screwdriver bit. It can be operated electrically or manually for different purposes. A conventional electric tool is provided with a motor to directly drive a clamping chuck through a decelerating mechanism. If the electric tool is used as an electric screwdriver, the motor is to directly drive the bit at the distal end of the clamping chuck for turning a screw, which generates a reverse force applied to the output shaft of the clamping chuck so that the motor is rotated accordingly. Thus, it cannot be directly used as a hand tool. Therefore, the output shaft of the decelerating mechanism is provided with a locking mechanism. Through the locking mechanism, the motor of the electric tool can clockwise output the power to drive the output shaft to rotate. When the output shaft is rotated in a reverse direction, the locking mechanism is to lock the output shaft, so that the output shaft cannot be rotated. In this way, the output shaft can be locked as a hand tool for use.

China Patent Application No. 200520009023.5 discloses a locking device of an electric tool output shaft, comprising a main shaft, a stop block, a power output disk, a stop ring, and a plurality of locking pins. The main shaft is inserted in the stop block and the power output disk. The main shaft is connected with ribs in the power output disk to output power. The main shaft cooperates with the stop block and the locking pins to accomplish a locking function. The main shaft and the locking pins of this locking device are connected through the stop block. Such a structure is complicated. The assembly is troublesome. The transmission is unstable and not smooth. The cost is high. Accordingly, the inventor of the present invention has devoted himself based on his many years of practical experiences to solve these problems.

### SUMMARY OF THE INVENTION

The primary object of the present invention is to solve the problems of the prior art and to provide a self-locking device of an electric tool output shaft, having the advantages of a simile structure, a convenient assembly, a stable and smooth transmission and being cost-effective.

In order to achieve the aforesaid object, a self-locking device of an electric tool output shaft of the present invention comprises a main shaft, a power output disk, a stop ring, and a plurality of self-locking pins. An upper end surface of the power output disk is provided with a plurality of drive blocks which are equally arranged along a circumferential direction. A bottom of the main shaft is inserted into the power output disk. The stop ring is fitted at outer sides of the plurality of drive blocks. The plurality of self-locking pins are each inserted in an interval between every two of the plurality of drive blocks and located between the stop ring and the main shaft. An inner side of the power output disk is provided with a plurality of drive surfaces corresponding to the respective drive blocks. An outer wall of a lower end of the main shaft is provided with a plurality of driven surfaces for leaning against the respective drive surfaces and a plurality of self-locking surfaces for leaning against the respective self-locking pins. The plurality of driven surfaces and the plurality of self-locking surfaces are equally spaced along a circumferential direction of the main shaft and disposed on the outer wall of the lower end of the main shaft.

Preferably, each drive surface consists of two vertical planes arranged at an angle and protruding inward to form a V-shaped angular configuration.

Preferably, the number of the drive blocks, the self-locking pins, the drive surfaces, the driven surfaces, and the self-locking surfaces is three, respectively.

Preferably, an inner surface and an outer surface of each drive block are curved surfaces.

Preferably, a maximum diameter of a circle enclosed by the plurality of drive blocks is less than an outer diameter of the power output disk.

Preferably, the plurality of drive surfaces are disposed on an inner surface of each drive block, respectively.

Preferably, the power output disk has a central axial hole therein, and the plurality of drive surfaces are equally arranged in a circumferential direction of the axial hole and disposed on an inner surface of the axial hole.

Preferably, each drive surface extends upward to an inner surface of a corresponding one of the drive blocks.

The beneficial effects of the present invention are described hereinafter. The self-locking device of the electric tool output shaft of the present invention comprises the main shaft, the power output disk, the stop ring, and the plurality of self-locking pins. The upper end surface of the power output disk is provided with the plurality of drive blocks which are equally arranged along the circumferential direction. The bottom of the main shaft is inserted into the power output disk. The stop ring is fitted at the outer sides of the plurality of drive blocks. The plurality of self-locking pins are each inserted in an interval between every two of the plurality of drive blocks and located between the stop ring and the main shaft. The inner side of the power output disk is provided with a plurality of drive surfaces corresponding to the respective drive blocks. The outer wall of the lower end of the main shaft is provided with the plurality of driven surfaces for leaning against the respective drive surfaces and the plurality of self-locking surfaces for leaning against the respective self-locking pins. The plurality of driven surfaces and the plurality of self-locking surfaces are equally spaced along the circumferential direction of the main shaft and disposed on the outer wall of the lower end of the main shaft. The main shaft has the driven surfaces to lean against the drive surfaces and the power output disk to accomplish a power output function, and further has the self-locking surfaces to lean against the self-locking pins to accomplish a self-locking function. The present invention integrates the function of a traditional stop block to the main shaft, with the self-locking surfaces instead of the stop block. The structure is simplified and more compact. The volume is reduced, the assembly is convenient, the cost is saved, the transmission is stable and smooth, and the service life is longer.

### BRIEF DESCRIPTION OF THE DRAWINGS

FIG. 1 is a perspective view of the present invention;

FIG. 2 is an exploded view of the present invention;

FIG. 3 is a sectional view of the present invention, without the main shaft;

FIG. 4 is a perspective view of the power output disk of the present invention;

FIG. 5 is a perspective view of another embodiment of the power output disk of the present invention; and

FIG. 6 is a perspective view of a further embodiment of the power output disk of the present invention.

### DESCRIPTION OF THE PREFERRED EMBODIMENTS

Embodiments of the present invention will now be described, by way of example only, with reference to the accompanying drawings.

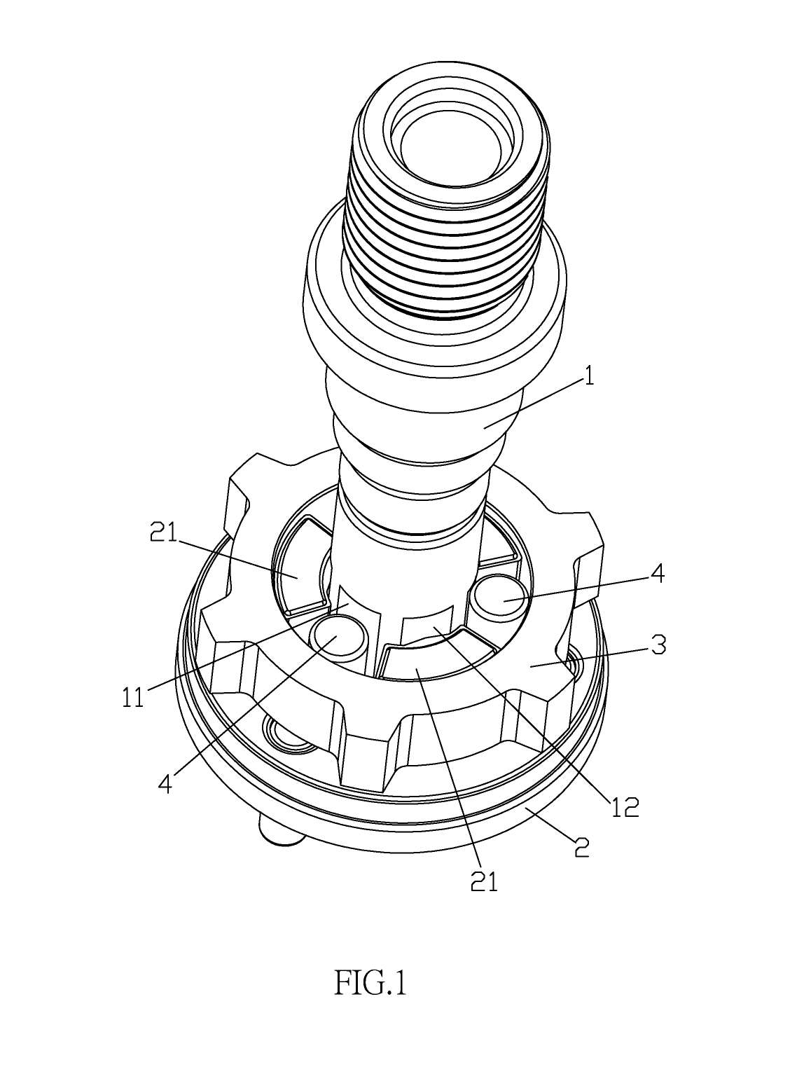

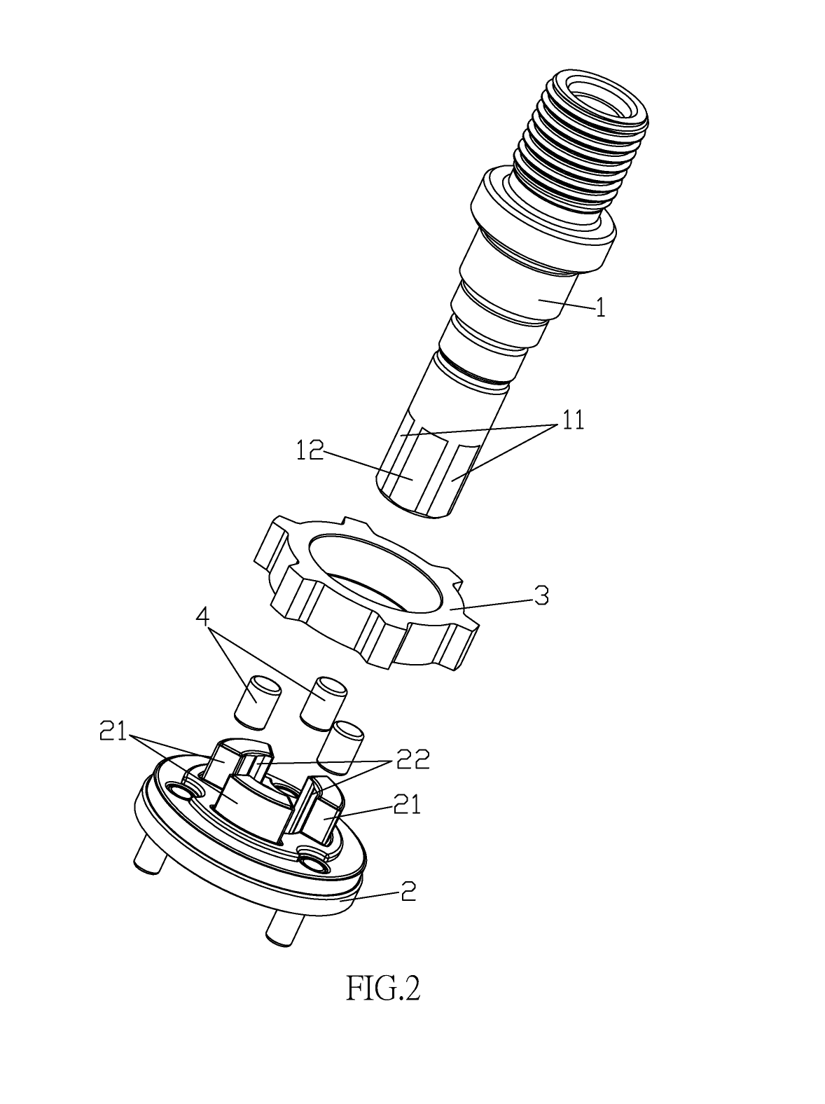

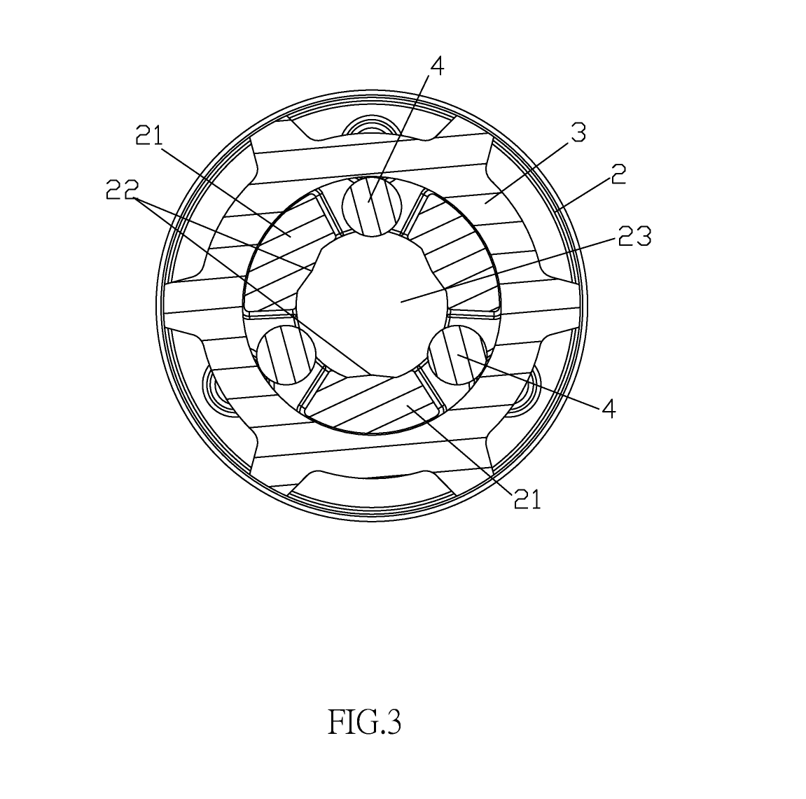

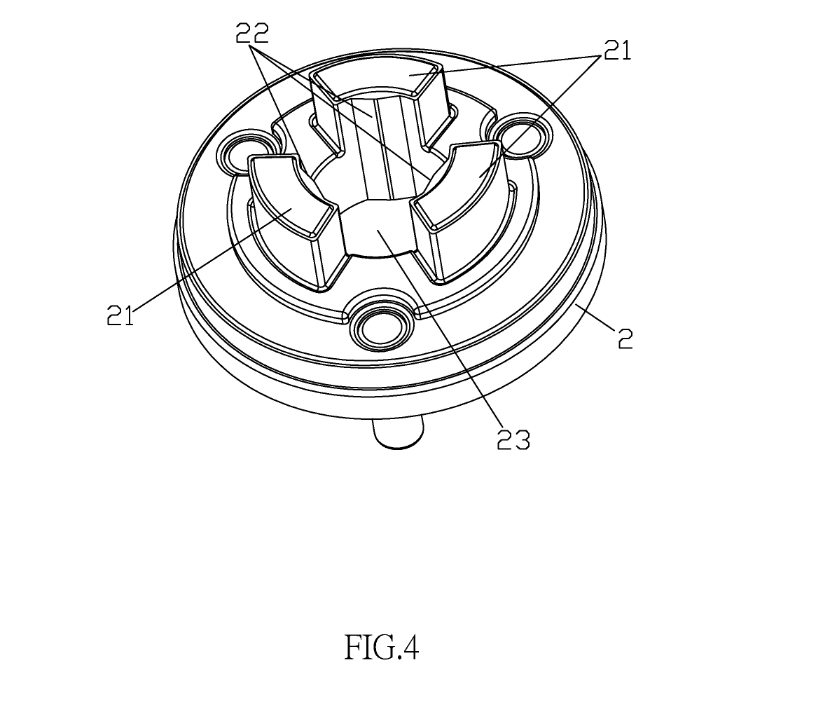

As shown in FIG. 1 through FIG. 4, the present invention comprises a main shaft 1, a power output disk 2, a stop ring 3, and a plurality of self-locking pins 4. An upper end surface of the power output disk 2 is provided with a plurality of drive blocks 21 which are equally arranged along the circumferential direction. The bottom of the main shaft 1 is inserted into the power output disk 2. The stop ring 3 is fitted at the outer sides of the plurality of drive blocks 21. The plurality of self-locking pins 4 are each inserted in an interval between every two of the plurality of drive blocks 21 and located between the stop ring 3 and the main shaft 1. The inner side of the power output disk 2 is provided with a plurality of drive surfaces 22 corresponding to the respective drive blocks 21. The outer wall of the lower end of the main shaft 1 is provided with a plurality of driven surfaces 12 for leaning against the respective drive surfaces 22 and a plurality of self-locking surfaces 11 for leaning against the respective self-locking pins 4. The plurality of driven surfaces 12 and the plurality of self-locking surfaces 11 are equally spaced along the circumferential direction of the main shaft 1 and disposed on the outer wall of the lower end of the main shaft 1. The number of the driven surfaces 12 is equal to that of the self-locking surfaces 11. The number of the drive blocks 21, the self-locking pins 4, the drive surfaces 22, the driven surfaces 12, and the self-locking surfaces 11 is three, respectively. The number may be two, four, five, eight, and so on, but not limited thereto.

Each drive surface 22 consists of two vertical planes arranged at an angle and protruding inward to form a V-shaped angular configuration, which has a better push force relative to the respective driven surfaces 12 of the main shaft 1. Both the inner surface and the outer surface of each drive block 21 are curved surfaces to cooperate with the main shaft 1 and the stop ring 3 better.

The maximum diameter of the circle enclosed by the plurality of drive blocks 21 is less than the outer diameter of the power output disk 2, such that the stop ring 3 can be pressed against the upper end surface of the power output disk 2 after the stop ring 3 is fitted at the outer sides of the plurality of drive blocks 21.

The power output disk 2 has a central axial hole 23 therein. In order to enhance the internal strength of the power output disk 22, the plurality of drive surfaces 22 are equally arranged in the circumferential direction of the axial hole 23 and disposed on the inner surface of the axial hole 23. Each drive surface 22 extends upward to the inner surface of the corresponding drive block 21.

The main shaft 1 of the present invention has the driven surfaces 12 to lean against the drive surfaces 22 and the power output disk 2 to accomplish a power output function, and further has the self-locking surfaces 11 to lean against the self-locking pins 4 to accomplish a self-locking function. The present invention integrates the function of a traditional stop block to the main shaft 1, with the self-locking surfaces 11 instead of the stop block. The structure is simplified and more compact. The volume is reduced, the assembly is convenient, the cost is saved, the transmission is stable and smooth, and the service life is longer.

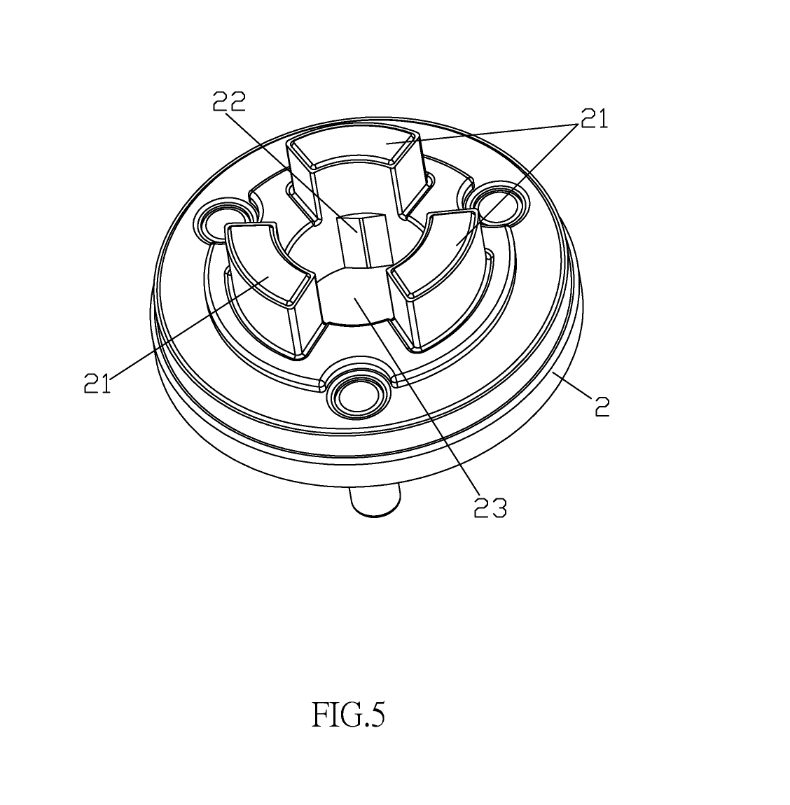

Another embodiment of the present invention, as shown in FIG. 5, is substantially similar to the aforesaid embodiment with the exceptions described hereinafter. The power output disk 2 has the central axial hole 23 therein. The plurality of drive surfaces 22 are equally arranged in the circumferential direction of the axial hole 23 and disposed on the inner surface of the axial hole 23. Each drive surface 22 doesn't extend to the inner surface of the corresponding drive block 21.

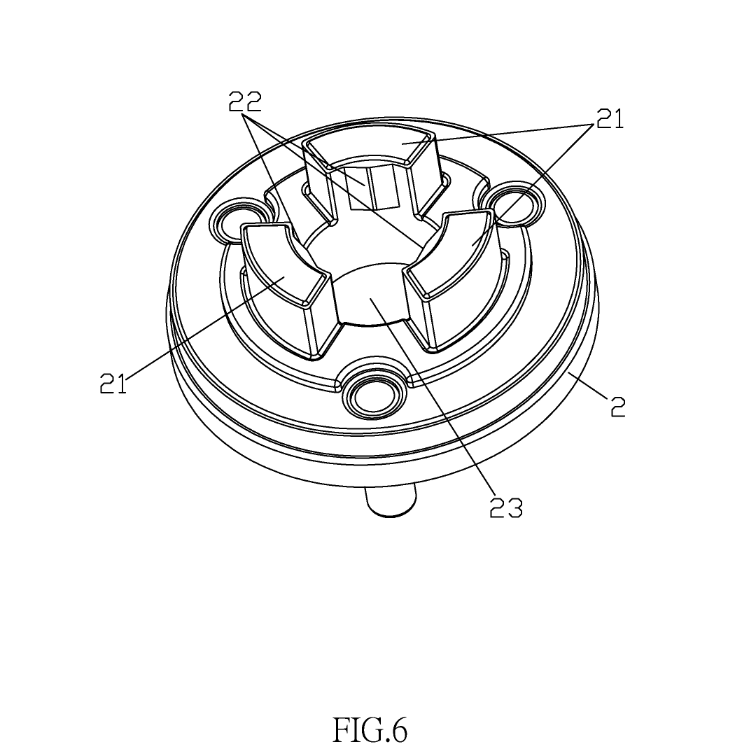

A further embodiment of the present invention, as shown in FIG. 6, is substantially similar to the aforesaid embodiment with the exceptions described hereinafter. The plurality of drive surfaces 22 are disposed on the inner surface of each drive block 21, respectively. The drive surfaces 22 don't extend to the inner surface of the axial hole 23.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A self-locking device of an electric tool output shaft, comprising a main shaft, a power output disk, a stop ring, and a plurality of self-locking pins, an upper end surface of the power output disk being provided with a plurality of drive blocks equally arranged along a circumferential direction, a bottom of the main shaft being inserted into the power output disk, the stop ring being fitted at outer sides of the plurality of drive blocks, characterized by: the plurality of self-locking pins being each inserted in an interval between every two of the plurality of drive blocks and located between the stop ring and the main shaft, an inner side of the power output disk being provided with a plurality of drive surfaces corresponding to the respective drive blocks, an outer wall of a lower end of the main shaft being provided with a plurality of driven surfaces for leaning against the respective drive surfaces and a plurality of self-locking surfaces for leaning against the respective self-locking pins, the plurality of driven surfaces and the plurality of self-locking surfaces being equally spaced along a circumferential direction of the main shaft and disposed on the outer wall of the lower end of the main shaft.

2. The self-locking device of an electric tool output shaft as claimed in claim 1, wherein each drive surface consists of two vertical planes arranged at an angle and protruding inward to form a V-shaped angular configuration.

3. The self-locking device of an electric tool output shaft as claimed in claim 1, wherein the number of the drive blocks, the self-locking pins, the drive surfaces, the driven surfaces, and the self-locking surfaces is three, respectively.

4. The self-locking device of an electric tool output shaft as claimed in claim 1, wherein an inner surface and an outer surface of each drive block are curved surfaces.

5. The self-locking device of an electric tool output shaft as claimed in claim 1, wherein a maximum diameter of a circle enclosed by the plurality of drive blocks is less than an outer diameter of the power output disk.

6. The self-locking device of an electric tool output shaft as claimed in claim 1, wherein the plurality of drive surfaces are disposed on an inner surface of each drive block, respectively.

7. The self-locking device of an electric tool output shaft as claimed in claim 1, wherein the power output disk has a central axial hole therein, and the plurality of drive surfaces are equally arranged in a circumferential direction of the axial hole and disposed on an inner surface of the axial hole.

8. The self-locking device of an electric tool output shaft as claimed in claim 7, wherein each drive surface extends upward to an inner surface of a corresponding one of the drive blocks.
